(19) United States
(12) Patent Application Publication
(10) Pub. No.: US 2008/0159336 A1
(43) Pub. Date: Jul. 3, 2008

(54) POWER CONTROL TECHNIQUES FOR BUS INTERFACES

(76) Inventor: Blaise Fanning, Folsom, CA (US)

Correspondence Address: KACVINSKY LLC;C/O INTELLEVATE, P.O. BOX 52050, MINNEAPOLIS, MN, 55402, US

(21) Appl. No.: 11/618,845

(22) Filed: Dec. 31, 2006

(51) Int. Cl. H04J 3/00

(52) U.S. Cl. 370/498

(57) ABSTRACT

Techniques are disclosed involving the transfer of signals across interconnection media. For instance, an apparatus may include a configuration module and a driver module. The configuration module may select one or more of multiple phase intervals within a time duration. This time duration may correspond to the time period length employed in a sequence of time periods. The driver module provides an interconnection medium with an output signal during one of the time periods. The output signal has an input signal level during the selected phase interval(s) of the period. During any remaining phase intervals of the time period, the driver module provides an alternate signal level.

### BACKGROUND

Many devices include multiple electronic components that exchange information with each other. Such information may be exchanged across interconnection media in the form of electrical signals. For example, interfaces known generally as buses may distribute information between components of a computer.

Certain signaling protocols may impose certain requirements for transmitting or driving electrical signals across a medium. Such requirements are often aimed at ensuring certain performance capabilities. For example, signaling protocols may impose requirements to ensure that a bus interface may provide for connectivity across a particular maximum distance. For certain devices, however, such performance capabilities may not be desirable.

### BRIEF DESCRIPTION OF THE DRAWINGS

FIG. 1 illustrates one embodiment of an apparatus.

FIG. 2 illustrates an exemplary implementation embodiment that may be included within a driver module.

FIG. 3 illustrates one embodiment of a logic diagram.

FIGS. 4A and 4B illustrate exemplary systems.

### DETAILED DESCRIPTION

Various embodiments may be generally directed to techniques involving the transfer of signals across interconnection media. For instance, in embodiments, an apparatus may include a configuration module and a driver module. The configuration module may select one or more of multiple phase intervals within a time duration. This time duration may correspond to the time period length employed in a sequence of time periods. The driver module provides an interconnection medium (e.g., a signal line in a bus interface) with an output signal during one of the time periods. The output signal has an input signal level during the selected phase interval(s) of the period. During any remaining phase intervals of the time period, the driver module provides an alternate signal level.

The apparatus may further include a receiver module that receives a transmission signal from the interconnection medium. The transmission signal may have an information-bearing logic level during the selected phase interval(s) and the alternate signal level during any remaining phase intervals. Additionally, the receiver module may provide a coupled device with the information-bearing logic level.

As described herein, embodiments may advantageously provide for reduced power consumption. In addition, embodiments may provide for reduced heat dissipation.

Embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

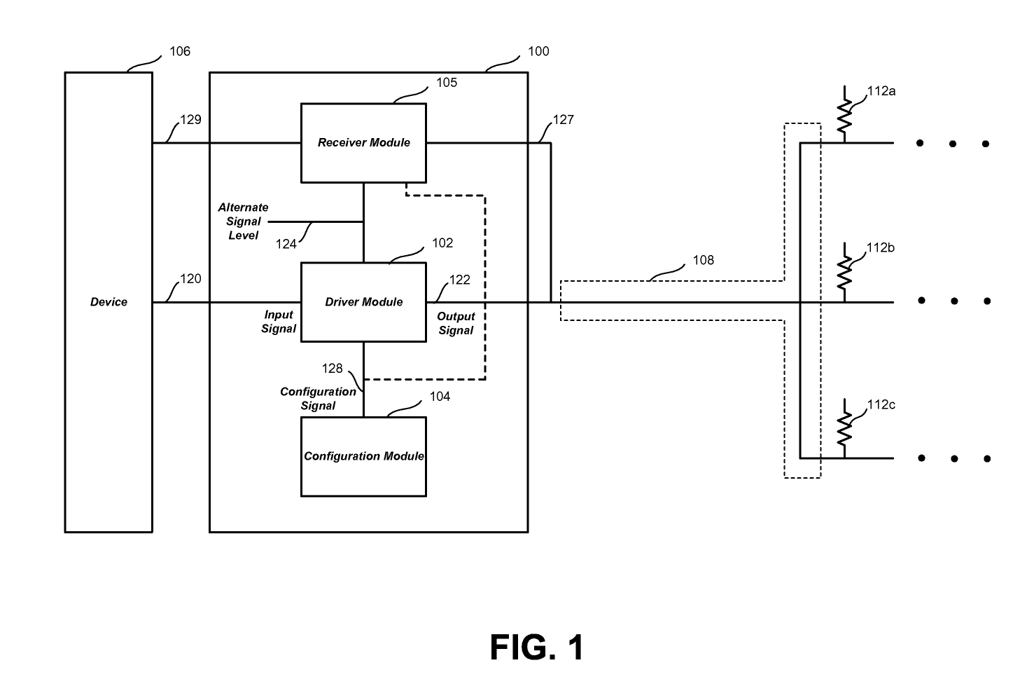

FIG. 1 illustrates one embodiment of an apparatus that may control the power used in transferring signals across an interconnection medium. In particular, FIG. 1 shows an apparatus 100 comprising various elements. The embodiments, however, are not limited to these depicted elements. As shown in FIG. 1, apparatus 100 may include a driver module 102, a configuration module 104, and a receiver module 105. These elements may be implemented in hardware, software, firmware, or any combination thereof.

Driver module 102 receives an input signal 120 and provides or drives an interconnection medium 108 with a corresponding output signal 122. Input signal 120 may be a baseband digital logic signal, which conveys a sequence of one or more discrete values. Accordingly, input signal 120 may have a level associated with a particular logic value (e.g., a binary ‘0’ or ‘1’).

In driving interconnection medium 108 with output signal 122, driver module 102 may employ various signaling schemes or protocols. One such signaling scheme is gunning transceiver logic (GTL). The embodiments, however, are not limited to GTL.

FIG. 1 further shows that driver module 102 may receive or provide an alternate signal level 124, which may have a constant value. Also, alternate signal level 124 may be associated with a particular logic value.

As shown in FIG. 1, input signal 120 may be received from a device 106. Device 106 may be, for example, a microprocessor or a central processing unit (CPU). However, device 106 may be other devices. Examples of such devices include microcontrollers, application specific integrated circuits (ASICs), memory devices, and so forth. The embodiments are not limited to such examples.

Output signal 122 may be driven across interconnection medium 108 for a time period having multiple time intervals within it. In generating output signal 122, driver module 102 may provide the level of input signal 120 for one or more of these time intervals. These time intervals may be the last one or more (contiguous) time intervals of the time period. For the remaining time intervals (if any), driver module 102 provides the alternate signal level 124.

Configuration module 104 establishes the number of time interval(s) during which driver module 102 will provide interconnection medium 108 with the level of input signal 120. This involves sending a configuration signal 128 to driver module 102. Configuration module 104 may set this number of time intervals during operation of apparatus 100. Such operations may be based on, for example, available power, and/or user selection. Accordingly, configuration module 104 may be implemented with hardware, software, firmware, or a combination thereof.

Alternatively, the number of time intervals may be preconfigured before operation. Preconfiguration techniques may include hardwiring, setting of switches or jumpers, configuring memory (e.g., read only memory) and so forth. The embodiment, however, are not limited to these examples. Accordingly, in cases where such preconfiguration occurs, configuration module 104 may generate configuration signal 128 such that it has a constant value.

Interconnection medium 108 provides for communication between components or devices. For example, interconnection may be a line within a computer bus interface. For purposes of illustration, FIG. 1 shows interconnection medium 108 being coupled to pull-up resistors 112a, 112b, and 112c. These resistors are each associated with receiving components of a corresponding device (not shown). Although three resistors are shown in FIG. 1, the embodiments, however, are not limited to a particular number of devices being coupled to interconnection medium 108.

As described above, interconnection medium 108 may be included in a bus interface, such as a computer system front side bus (FSB) or processor bus. Also, interconnection medium may employ GTL signaling. GTL provides for signals between 0.4 volts and 1.2 volts. In addition, GTL signaling protocols establish various requirements. One exemplary requirement mandates the employment of pull-up resistors at every connected agent device. Such pull-up resistors are typically on the order of 50 to 100 ohms. Referring again to FIG. 1, resistors 112a, 112b, and 112c are examples of such pull-up resistors. Also, as described above, GTL signals employ voltage levels that may vary around approximately 1 volt (e.g., between 0.4 and 1.2 volts). As a result, a GTL signal that is pulled down every bus clock cycle may consume approximately 10 to 20 milliwatts of system power per non-driving connection.

Such requirements are directed at providing very clean signaling on an interface that is operating over a relatively large distance (e.g., approximately one foot in length) and is approaching the interface's maximum plausible signal frequencies, given its technology generation. However, in many devices, providing clean signaling at such large distances requirements can be excessive.

For example, in very small devices like laptop, notebook, and ultra-mobile personal computers (PCs), trace lengths for processor bus signals are often short. More particularly, such trace signals are often short in relationship to the period of the signal employed by the signaling protocol (e.g., GTL). Thus, pulling against the resistor for the entire cycle-time may not be needed, since the flight times of the signals will be substantially reduced.

Thus, apparatus 100 provides for reducing a signal's drive time. This reduction may advantageously reduce power consumption associated with interfaces, such as computer buses. More particularly, apparatus 100 may drive interconnection medium 108 with level(s) of input signal 120 according to a fractional “duty cycle”.

This involves driver module 102 driving interconnection medium 108 with output signal 122 such that its level during a particular time period is either the level of input signal 120 or of alternate signal level 124. With reference to FIG. 1, alternate signal level 124 may be a sufficiently high voltage such that when it is driven onto interconnection medium 108, little or no current is drawn across resistors 112.

The time period may be in a sequence of time periods. For instance, this time period may be a computer bus cycle. However, the embodiments are not limited to this context.

Device 106 may generate input signal 120 at a rate that is different than the rate employed by a interconnection medium 108. For purposes of illustration, interconnection medium 108 operates at a frequency or rate (i.e., the inverse of the aforementioned time period) that is four times the frequency or rate device 106 employs in generating input signal 120. The embodiments, however, are not limited to this relationship. Thus, the aforementioned time period (e.g., computer bus cycle) may be divided into four intervals or phases (also referred to herein as phase0, phase1, phase2, and phase3).

Based on a setting that is established by configuration module 104, driver module 102 may drive interconnection medium 108 with input signal 120 during one or more phases of each repeating time period (e.g., bus cycle). As described above, these may be the last phase interval(s) of the time period. For any remaining phase intervals of the time period, interconnection medium 108 is driven by alternate signal level 124. As shown in FIG. 1, configuration module 104 may send the setting to driver module 102 in the form of configuration signal 128.

Thus, the drive time for output signal 122 may be reduced by 25 percent, 50 percent, or 75 percent. As described above, this may advantageously reduce power consumption in the transfer of signals between devices or components.

As described above, apparatus 100 further includes receiver module 105. Receiver module 105 may include a pull-up resistor coupled to interconnection medium 108, as well as various baseband or logic circuitry. As shown in FIG. 1, receiver module 105 is coupled to interconnection medium 108. Accordingly, receiver module 105 may receive a transmission signal 127 from interconnection medium 108.

Like output signal 122, transmission signal 127 may have an information-bearing logic level during the one or more selected phase intervals, and an alternate signal level during any remaining phase intervals. As described above, the one or more selected phase intervals may be the last one or more (contiguous) phase intervals of a time period. Thus, receiver module 105 may determine the logic level by detecting the level of signal 127 during the last phase interval. Upon this determination, receiver module 105 may provide the information-bearing logic level to device 106 in the form of a logic signal 129.

Alternatively, in implementations where the selected phase interval(s) are not the last occurring interval(s) of the time period, receiver module 105 may determine the logic level based on configuration signal 128. Accordingly, a dotted line in FIG. 1 shows that configuration signal 128 may be sent to receiver module 105 for such implementations.

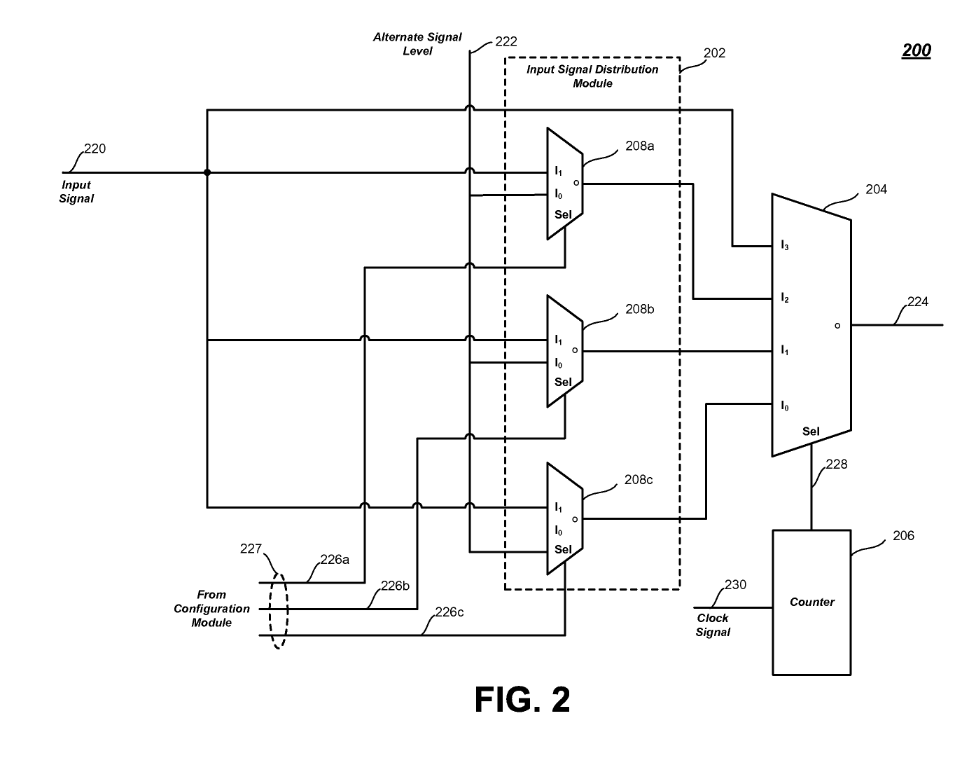

FIG. 2 is a diagram of an implementation 200 that may be employed in driver module 102. Implementation 200 may include various elements. For instance, FIG. 2 shows implementation 200 including an input signal distribution module 202, a multiplexer 204, and a counter 206. These elements may be implemented in hardware, software, firmware, or any combination thereof.

Input signal distribution module 202 determines the particular signals sent to multiplexer 204. As shown in FIG. 2, input signal distribution module 202 may include one or more multiplexers. For instance, FIG. 2 shows input signal distribution module 202 comprising multiplexers 208a, 208b, and 208c. Each multiplexer 208 includes two input terminals, an input terminal (I₀) to receive an alternate signal level 222, and an input terminal (I₁) to receive an input signal 220. With reference to FIG. 1, input signal 220 may be implemented with input signal 120, and alternate signal level 222 may be implemented with alternate signal level 124.

FIG. 2 also shows that each multiplexer 208 further includes an output terminal (O), and a control interface (Sel). The control interface for each of multiplexers 208a-c receives a control signal 226. More particularly, FIG. 2 shows multiplexer 208a receiving a control signal 226a, multiplexer 208b receiving a control signal 226b, and multiplexer 208c receiving a control signal 226c. Each control signal 226 may represent a binary value that determines which of input terminals I₁ and I₂ is coupled to output terminal, O. Together, control signals 226a-c form a control word 227. Control word 227 may be generated by and received from an entity, such as configuration module 104 of FIG. 1.

As described above, input signal distribution module 202 receives control word 227 (or signals 226). The value of control word 227 determines which input terminals of multiplexer 204 receives input signal 220 and which input terminals (if any) receive alternate signal level 222.

Multiplexer 204 includes multiple input terminals (indicated in FIG. 2 as I₀, I₁, I₂, and I₃). Each input terminal corresponds to a particular time interval or phase within a time period, such as a cycle time of a bus interface.

FIG. 2 also shows that multiplexer 204 includes an output terminal (O), and a control interface (Sel). This control interface receives a counter signal 228. Counter signal 228 may represent a binary value that determines which of input terminals I₀, I₁, I₂, and I₃ is coupled to output terminal, O. Counter signal 228 may be in the form of multiple (e.g., two) bit word that increments in a circular manner. This word may increment in value such that the input terminals of multiplexer 204 are sequentially coupled to the output terminal of multiplexer 204. More particularly, this sequential coupling of input terminals may occur in the following order: I₀, I₁, I₂, I₃. This sequence may occur repeatedly.

As described above, a time period (e.g., a bus cycle) having multiple intervals or phases may be associated with interconnection medium 108. For example, an exemplary bus cycle may have four phases (phase0, phase1, phase2, and phase3). Counter signal 228 may be incremented in synchronization with these phases, as indicated below in Table 1.

TABLE 1

| Counter Value | Corresponding Phase | Selected Input Terminal |
|---|---|---|
| 0 | Phase0 | I₀ |
| 1 | Phase1 | I₁ |
| 2 | Phase2 | I₂ |
| 3 | Phase3 | I₃ |

FIG. 2 shows counter 206 generating counter signal 228 from a clock signal 230. However, the embodiments are not limited as such. For instance, implementation 200 may alternatively receive counter signal 228 from an external source. Thus, such implementations may not include counter 206.

As described above, input signal distribution module 202 determines the particular signals sent to multiplexer 204. More particularly, input signal distribution module 202 provides different signals to the input terminals of multiplexer 204 based on the driving times selected for driving signals across a medium (e.g., interconnection medium 108). An exemplary distribution of input signals to the input terminals of multiplexer 204 is provided below in Table 2. More particularly, Table 2 includes multiple rows, each corresponding to a particular driving time percentage across an interconnection medium. For each row, the second through fifth columns indicate the signals received at the input terminals of multiplexer 204. In these entries, “A” designates alternate signal level 222, while “I” designates the level of input signal 220.

TABLE 2

| Driving | | | | |
|---|---|---|---|---|
| Percentage | I₀ | I₁ | I₂ | I₃ |
| 25% | A | A | A | I |
| 50% | A | A | I | I |
| 75% | A | I | I | I |

As shown in the example of Table 2, I₀ through I₃ may receive signal levels such that the last one or more phase intervals provide the level of input signal 220.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

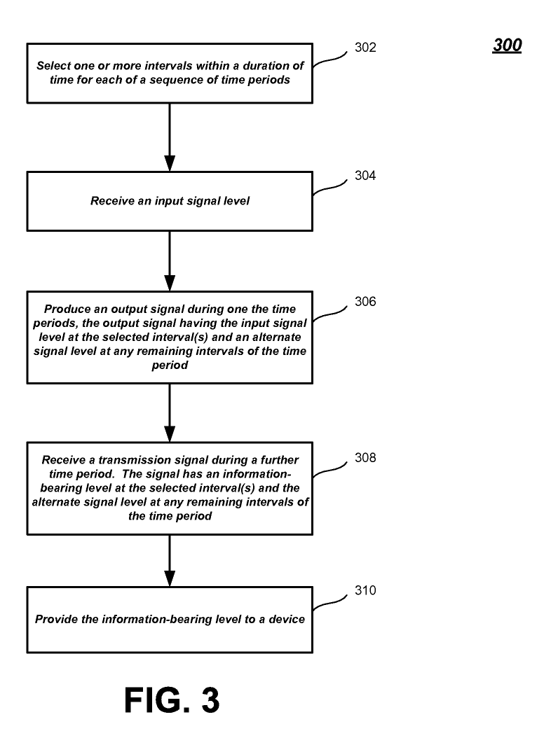

FIG. 3 illustrates one embodiment of a logic flow. In particular, FIG. 3 illustrates a logic flow 300, which may be representative of the operations executed by one or more embodiments described herein. As shown in logic flow 300, a block 302 selects one or more intervals within a time duration. This duration may be the duration for each of a sequence of time periods (e.g., a sequence of bus cycles). In the context of FIG. 1, this may be implemented with configuration module 104.

A block 304 receives an input signal level. With reference to FIG. 1, this input signal level may be received from a device or component, such as device 106.

From this input signal, a block 306 produces an output signal based on the selection of block 302. More particularly, block 306 may produce an output signal (such as output signal 122) during one of the time periods. This output signal may have the input signal level at the selected interval(s) and an alternate signal level at any remaining (or unselected) intervals of the time period.

Embodiments may further include reception aspects. For instance, FIG. 3 includes a block 308, which receives a transmission signal during a particular time period. This time period may be a different one (e.g., a different bus cycle) than when the output signal of block 306 is produced. This transmission signal may be received from a medium, such as interconnection medium 108. Thus, this transmission may originate from a further device or component.

The received transmission signal may be in a format similar to the format of the signal produced by block 306. For instance, the received transmission signal may have an information-bearing level at the selected interval(s) and the alternate signal level at any remaining (or unselected) intervals of the time period.

Based on this, a block 310 provides the information-bearing level to a coupled device. With reference to FIG. 1, block 310 may be implemented with receiver module 105.

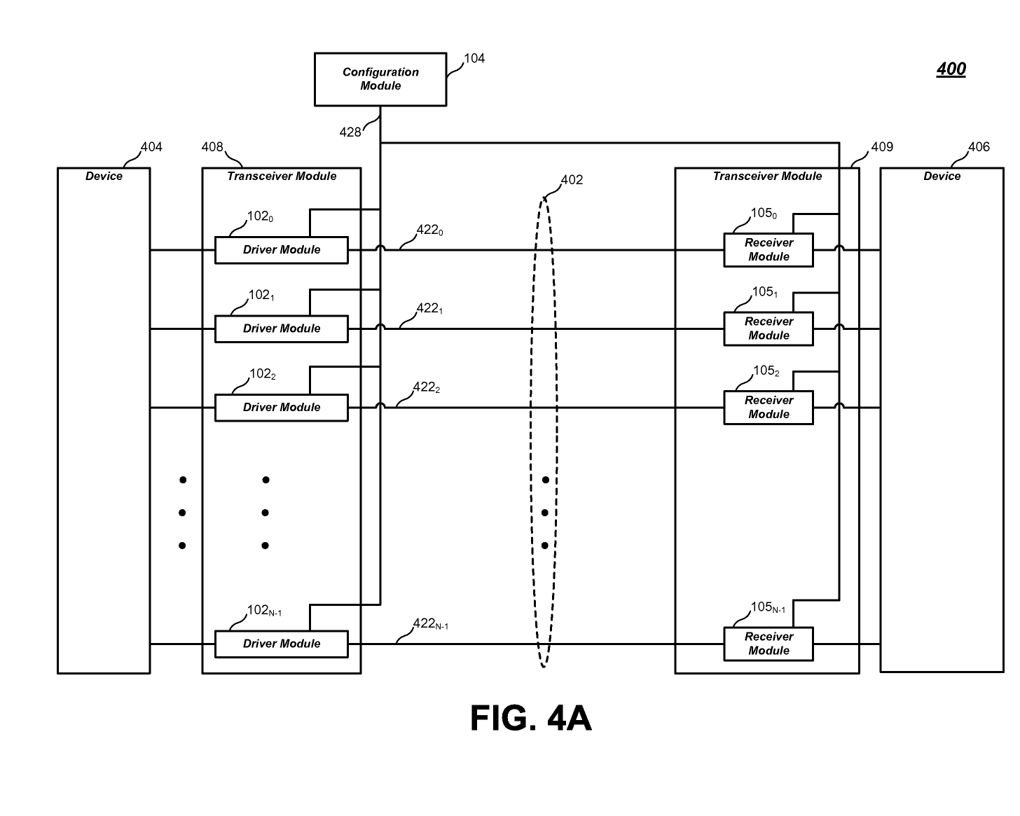

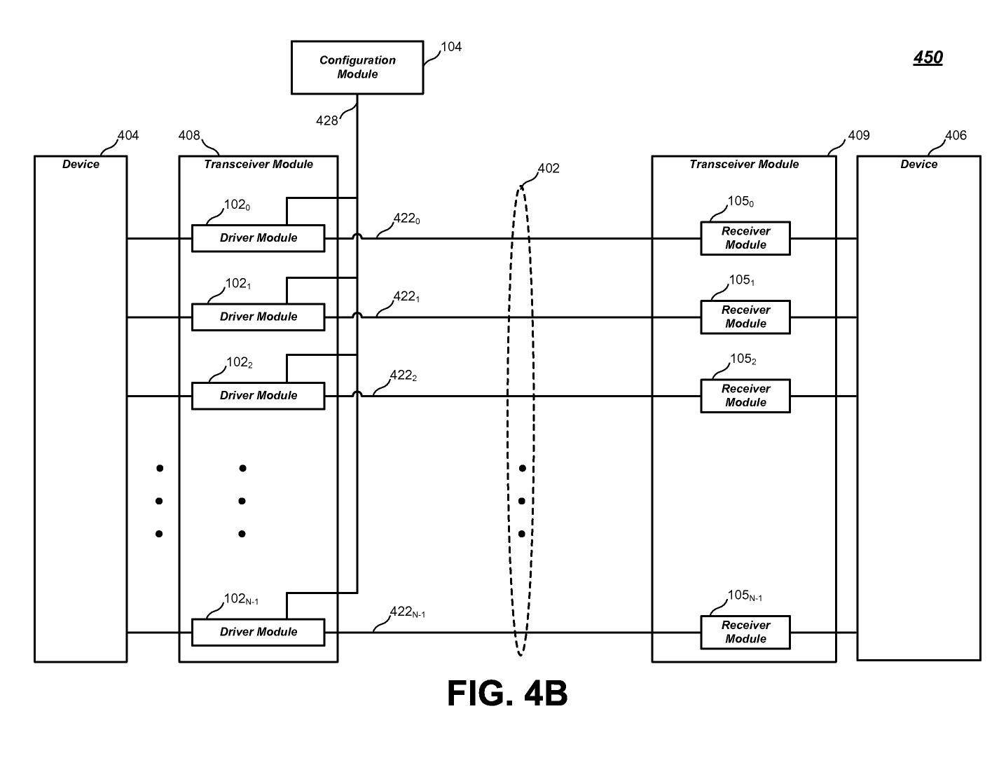

FIG. 4A is a diagram of an exemplary system embodiment. In particular, FIG. 4 is a diagram showing a system 400, which may include various elements. For instance, FIG. 4 shows that system 400 may include a configuration module 104, a bus interface 402, a device 404, a device 406, a transceiver module 408, and a transceiver module 409. These elements may be implemented in hardware, software, firmware, or any combination thereof.

Bus interface 402 may include multiple signal lines. For instance FIG. 4A shows bus interface 402 having N signal lines (422₀-422_{N-1}). Bus interface 402 provides connectivity between devices 404 and 406. The embodiments, however, are not limited as such. For instance, bus interface 402 may provide connectivity among various numbers of devices. Thus, bus interface 402 may be employed in various contexts. For example, bus interface 402 may be employed as a front side bus (FSB) or computer bus. An FSB bus may provide for bi-directional communication of information between a central processing unit (CPU) and other devices. Examples of other devices include random access memory (RAM), video cards, PCI expansion cards, hard disks, read only memory, and so forth.

FIG. 4A shows that devices 404 and 406 are connected to bus interface 402 by transceiver modules 408 and 409, respectively. Transceiver modules 408 and 409 transmit logic signals across bus interface 402 at a rate or frequency which is based on a bus cycle period. The transfer of such signals may be in accordance with one or more signaling schemes or protocols, such as GTL. The embodiments, however, are not limited to GTL.

Transceiver module 408 is shown having multiple driver modules 102₀-102_{N-1}. Each of these driver modules is coupled to a particular signal line 422. As described above with reference to FIG. 1, each driver module 102 may drive its coupled signal line 422 with input signal levels during phase interval(s) selected by configuration module 104. During any remaining phase intervals, each driver module 102 may drive its coupled signal line 422 with an alternate signal level.

FIG. 4A shows transceiver module 409 having multiple receiver modules 105₀-105_{N-1}, which are each coupled to a corresponding signal line 422. As described above with reference to FIG. 1, each receiver module 105 may receive transmission signals from its coupled signal line 422. These signals may have an information-bearing logic level during the one or more selected phase intervals, and an alternate signal level during any remaining phase intervals. Upon receipt of such signals, receiver modules 105 provide the information-bearing logic level to its coupled device (e.g., device 406).

For purposes of clarity, FIG. 4A shows transceiver module 408 only having driver modules 102 and transceiver module 409 only having receiver modules 105. However, transceiver modules 408 and 409 may each have driver modules 102 and receiver modules 105 to provide bidirectional communications capabilities.

Configuration module 104 selects one or more phase intervals of the bus cycle period. As shown in FIG. 4A, this selection is provided to transceiver module 408 in the form of a configuration signal 428. Based on configuration signal 428, transceiver modules 408 may drive, signals across bus interface 402 according to the techniques described herein.

As described herein, the one or more selected phase intervals may be the last phase interval(s) of the time period (bus cycle). Accordingly, in such implementations, configuration module 104 does not need to send configuration signal 428 to transceiver module 409. This is because, receiver modules 105 may determine information-bearing logic levels through detection during the last occurring phase interval. Accordingly, FIG. 4B shows a system 450 in which configuration signal 428 is not sent to transceiver module 409.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a configuration module to select one or more of multiple phase intervals within a time duration, the time duration corresponding to each time period in a sequence of time periods; and
a driver module to provide an interconnection medium with an output signal during one of the time periods, the output signal having an input signal level during the one or more selected phase intervals of the one time period and having an alternate signal level during any remaining phase intervals of the one time period.

2. The apparatus of claim 1, wherein the driver module includes a multiplexer, the multiplexer comprising:
a plurality of input terminals, each input terminal corresponding to one of the multiple phase intervals within the repeating time period;
an output terminal; and
a control interface to receive a control signal, the control signal to couple one of the input terminals to the output terminal during its corresponding phase interval.

3. The apparatus of claim 2, wherein the driver module includes an input signal distribution module to provide the input signal level to each of the input terminals of the multiplexer corresponding to each selected phase interval, and to provide the alternate signal level to any remaining input terminals of the multiplexer.

4. The apparatus of claim 3, further comprising the interconnection medium.

5. The apparatus of claim 4, wherein the interconnection medium is included in a bus interface, wherein the repeating time period is a repeating bus cycle.

6. The apparatus of claim 1, wherein the output signal, when at the alternate signal level, is to draw substantially no electrical current across the interconnection medium.

7. The apparatus of claim 1, wherein the output signal is a gunning transceiver logic (GTL) signal, and wherein the alternate signal is a GTL high level output voltage.

8. The apparatus of claim 1, further comprising a receiver module to receive a transmission signal from the interconnection medium during a further one of the time periods, the signal having an information-bearing logic level during the one or more selected phase intervals of the further time period and having an alternate signal level during any remaining phase intervals of the further time period.
wherein the receiver module is to provide the information-bearing logic level to a device.

9. The apparatus of claim 8, wherein the receiver module comprises a pull-up resistor coupled to the interconnection medium.

10. The apparatus of claim 1, wherein the one or more selected phase intervals are the last one or more contiguously occurring phase intervals in the time duration.

11. A method, comprising:
selecting one or more of multiple phase intervals within a time duration, the time duration corresponding to each time period in a sequence of time periods associated with an interconnection medium;
receiving an input signal; and
producing an output signal during one of the time periods, the output signal having an input signal level during the one or more selected phase intervals of the one time period and having an alternate signal level during any remaining phase intervals of the one time period.

12. The method of claim 11, wherein said producing comprises driving the interconnection medium with the output signal

13. The method of claim 11, wherein the output signal, when at the alternate signal level, is to draw substantially no electrical current across the interconnection medium.

14. The method of claim 11, further comprising:
receiving a transmission signal from the interconnection medium during a further one of the time periods, the signal having an information-bearing logic level during the one or more selected phase intervals of the further time period and having an alternate signal level during any remaining phase intervals of the further time period; and
providing the information-bearing logic level to a device.

15. The method of claim 11, wherein the output signal is a gunning transceiver logic (GTL) signal, and wherein the alternate signal is a GTL high level output voltage.

16. The method of claim 11, wherein the one or more selected phase intervals are the last one or more contiguously occurring phase intervals in the time duration.

17. A system, comprising:
a bus interface having a plurality of signal lines;
a configuration module to select one or more of multiple phase intervals within a time duration, the time duration corresponding to each time period in a sequence of time periods; and
for each of the signal lines, a driver module to provide the corresponding signal line with an output signal during one of the time periods, the output signal having an input signal level during the one or more selected phase intervals of the one time period and having an alternate signal level during any remaining phase intervals of the one time period.

18. The system of claim 17, wherein each of the driver modules includes a multiplexer, the multiplexer comprising:
a plurality of input terminals, each input terminal corresponding to one of the multiple phase intervals within the time period;
an output terminal; and
a control interface to receive a control signal, the control signal to couple one of the input terminals to the output terminal during its corresponding phase interval.

19. The system of claim 17, wherein each output signal, when at the alternate signal level, is to draw substantially no electrical current across the corresponding signal line.

20. The system of claim 17, further comprising:
for each of the signal lines, a receiver module to receive a transmission signal from the interconnection medium during a further one of the repeating time periods, the signal having an information-bearing logic level during the one or more selected phase intervals of the further time period and having an alternate signal level during any remaining phase intervals of the further time period.
wherein the receiver module is to provide the information-bearing logic level to a device.

21. The system of claim 20, wherein the device is a central processing unit.(CPU) coupled to each of the driver modules and each of the receiver modules.

22. The system of claim 16, wherein the bus interface is a front side bus (FSB).

23. The system of claim 16, wherein the one or more selected phase intervals are the last one or more contiguously occurring phase intervals in the time duration.
